(19) United States
(12) Patent Application Publication
(10) Pub. No.: US 2012/0242805 A1
(43) Pub. Date: Sep. 27, 2012

(54) IMAGING DEVICE, SYNCHRONIZATION CONTROL METHOD, REPRODUCTION DEVICE, AND STEREOSCOPIC VIDEO IMAGING SYSTEM

(76) Inventor: Syun TYOU, Kanagawa (JP)

(21) Appl. No.: 13/415,995

(22) Filed: Mar. 9, 2012

(30) Foreign Application Priority Data
Mar. 24, 2011 (JP) 2011-066254

(51) Int. Cl. H04N 13/02

(52) U.S. Cl. 348/47; 348/E13.073

(57) ABSTRACT

An imaging device includes an operation unit that instructs an operation by operation input, an imaging control unit that controls an operation of an imaging unit having a first imaging element, a counting unit that counts the number of generation times of the vertical synchronization signal, and a control unit that calculates the number of generation times of the vertical synchronization signal inserted between second processing frames based on a difference value between the number of generation times of the vertical synchronization signal generated by a second imaging element of the other imaging device and inserted between the second processing frames and the number of generation times of the vertical synchronization signal inserted between first processing frames, so as to notify the other imaging device of timing to start an instructed operation and an instruction, and perform the notified operation after elapse of a predetermined period.

### BACKGROUND

The present disclosure relates to an imaging device, a synchronization control method, a reproduction device, and a stereoscopic video imaging system that are preferable to be applied to a case where a stereoscopic video image (3D video image) is generated from video images picked up by two cameras, for example.

In related art, there is a technique to generate a stereoscopic video image (3D video image) which can be three-dimensionally viewed by a user, by using video images of a same subject picked up by two cameras which are disposed in a manner to correspond to parallax of right and left eyes of the user. In order to pick up a stereoscopic video image, start or stop of video recording or start or stop of video reproduction (referred to below as merely “start or stop of processing”) is performed in a manner to synchronize operations of two cameras.

Japanese Unexamined Patent Application Publication No. 2006-163640 discloses such technique that a plurality of video tape recorders are connected to a video camera in series and a first connector to which a recording signal is transmitted and a second connector to which return of a state confirmation signal is transmitted are bidirectionally connected.

### SUMMARY

By the way, a stereoscopic video imaging system of related art has not had a linkage function by which two cameras control mutual operations. Therefore, even though a user performs operation input with respect to each of two cameras, it has been difficult for the two cameras to simultaneously perform start or stop of processing due to mismatch of timings of the operation input. Here, if timings of start or stop of processing performed by two cameras, that is, processing frames of video signals which are picked up or reproduced by respective cameras are not exactly matched, feeling of strangeness is generated in a video image which is reproduced and three-dimensionally viewed, generating an imperfect video image. Therefore, start or stop timings of processing frames have had to be separately matched by using a time code or the like attached to respective clip files generated by two cameras.

Further, above-mentioned Japanese Unexamined Patent Application Publication No. 2006-163640 discloses the technique to continuously perform processing while making the plurality of video tape recorders confirm states. However, this technique is employed only in a case where video tape recorders are operated in conjunction with each other. Accordingly, in a case where two cameras are used so as to pick up stereoscopic video images, it is not Considered to rigorously control record or reproduction of a video image.

It is desirable to accurately match timings of processing when stereoscopic video images are processed by using two imaging devices.

An imaging device according to an embodiment of the present disclosure instructs an operation by operation input and controls an operation of an imaging unit having a first imaging element that outputs a video signal in a first processing frame for every vertical synchronization signal which is inserted between first processing frames, by incident light of a subject incident through a lens. Further, the imaging device counts the number of generation times of the vertical synchronization signal generated by the imaging element as the frame number of the first processing frames. Further, the imaging device obtains the number of generation times, which is notified from the other imaging device, of the vertical synchronization signal that is generated by a second imaging element of the other imaging device, which is connected to the imaging device by a control line that transmits a control signal, and are inserted between second processing frames. Here, the imaging device calculates the number of generation times of the vertical synchronization signal that is inserted between second processing frames based on a difference value between the generation number of vertical synchronization signals that are inserted between second processing frames and the number of generation times of the vertical synchronization signal that is inserted between the first processing frames. Then, the imaging device notifies the other imaging device of timing at which the other imaging device starts an instructed operation after elapse of a predetermined period and an instruction given by the operation input, based on the number of generation times of the vertical synchronization signal inserted between the second processing frames. Further, the imaging device performs the operation that is notified of after the elapse of the predetermined period from a time point on which the operation input is performed.

Accordingly, it has become possible to give instruction by operation input at timing on which instructed operation is started after elapse of a predetermined period between two imaging devices.

According to the embodiment of the present disclosure, a first imaging device notifies the other imaging device of timing on which the other imaging device starts an instructed operation after elapse of a predetermined period and an instruction given by operation input, and performs the notified operation after elapse of the predetermined period from a time point on which the operation input is performed. Accordingly, an operation instructed by operation input can be simultaneously performed and accuracy of start or stop of processing can be enhanced when a stereoscopic video image is processed by using two imaging devices.

### BRIEF DESCRIPTION OF THE DRAWINGS

FIG. 1 is a block diagram illustrating an external configuration example of a stereoscopic video imaging system according to an embodiment of the present disclosure;

FIG. 2 is a block diagram illustrating an internal configuration example of the stereoscopic video imaging system according to the embodiment of the present disclosure;

FIGS. 3A to 3C are timing diagrams illustrating examples that a first camera and a second camera mutually control timings of processing operations in the embodiment of the present disclosure;

FIG. 4 is a flowchart illustrating an example of processing of the first camera in the embodiment of the present disclosure;

FIG. 5 is a flowchart illustrating an example of processing, which is performed by a synchronization control unit, of an interface of a camera control unit in the embodiment of the present disclosure;

FIG. 6 is a flowchart illustrating an example of processing, which is performed by the synchronization control unit, of an interface of a user interface control unit in the embodiment of the present disclosure; and

FIG. 7 is a flowchart illustrating an example of processing, which is performed by the synchronization control unit, of an interface of a transmission/reception control unit in the embodiment of the present disclosure.

### DETAILED DESCRIPTION OF EMBODIMENTS

An embodiment of the present disclosure (referred to below as an embodiment) will be described below. The description will be given in the following order.

### 1. Embodiment. (Synchronization Control of Two Cameras: Example of Stereoscopic Video Imaging System)

### 2. Modification

### 1. Embodiment

### Example of Synchronization Control of Two Cameras

An embodiment of the present disclosure is now described with reference to the accompanying drawings. In this embodiment, a stereoscopic video imaging system 10 which picks up stereoscopic video images in a manner to synchronize timings of start or stop of processing of two cameras (imaging devices) is described as an example (referred to below as “this example”). The stereoscopic video imaging system 10 employs a synchronization control method for controlling synchronization of start or stop of processing of two cameras.

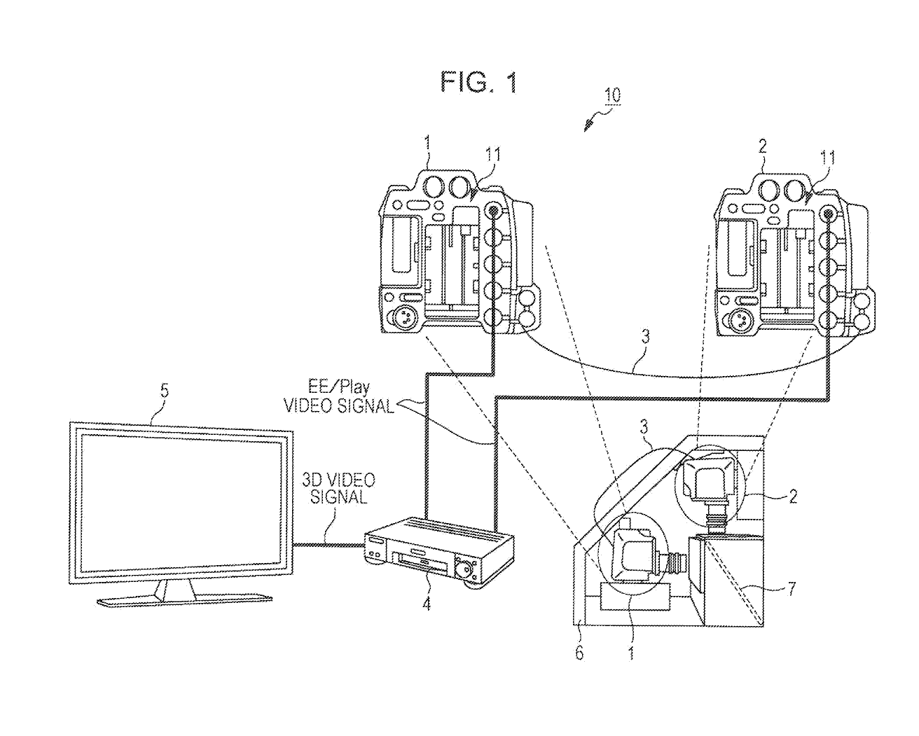

FIG. 1 illustrates an external configuration example of the stereoscopic video imaging system 10.

The stereoscopic video imaging system 10 includes a first camera 1 and a second camera 2 as imaging devices which pick up two-dimensional video images having the same picture size in one second in the same number of frames. The first camera 1 and the second camera 2 are provided with common line terminals. The first camera 1 and the second camera 2 can transmit/receive a synchronization control signal which is used for controlling to synchronize processing of record or reproduction of mutual video images in a frame unit, while putting the synchronization control signal in a communication packet by a synchronization control line 3 which is connected to the line terminals and capable of serial communication.

The first camera 1 and the second camera 2 include an operation unit 11 by which a user instructs each unit about an operation by operation input. As the operation unit 11, an operation switch (a recording button, a reproducing button, and the like) on the camera body, a remote controller which is not shown, a push button, a toggle switch, a touch panel display, and the like, for example, are used.

The stereoscopic video imaging system 10 further includes a signal converting device 4 which converts video signals inputted from the first camera 1 and the second camera 2 into a stereoscopic video signal. The signal converting device 4 outputs a two-dimensional or three-dimensional video signal to a display device 5 which is capable of displaying video images two-dimensionally or three-dimensionally.

The signal converting device 4 receives an electric to electric mode (EE) video signal or a Play video signal from the first camera 1 and the second camera 2. The EE video signal is a signal for instructing the display device 5 to display a two-dimensional video signal which is picked up by the first camera 1 and the second camera 2, as a two-dimensional video image directly. That is, the EE video signal is a video signal which is outputted by the first camera 1 and the second camera 2 and directly taken out, as an output with respect to the display device 5, without going through a recording unit such as HDD. The Play video signal is a signal for instructing the display device 5 to display two-dimensional video signals which are reproduced by the first camera 1 and the second camera 2 as a three-dimensional video image.

The signal converting device 4 outputs a communication packet which is obtained by combining two-dimensional video signals inputted from the first camera 1 and the second camera 2 as one three-dimensional video signal, to the display device 5. When the display device 5 is set in a two-dimensional display mode in which a two-dimensional video image is displayed, the display device 5 selects a video signal from video signals inputted from the first camera 1 and the second camera 2 and displays the selected video image selected from right and left video images as a two-dimensional video image. On the other hand, when the display device 5 is set in a three-dimensional display mode in which a three-dimensional video image is displayed, the display device 5 displays the video signals as a three-dimensional video image.

The first camera 1 and the second camera 2 are put on a putting table (RIG) 6 in stereoscopic video image pick up. Commonly, zoom magnification of the first camera 1 and the second camera 2 is set to be unmagnified and the first camera 1 and the second camera 2 are disposed so that an interval between lenses thereof corresponds to human eyes. A stereoscopic video image obtained by combining two-dimensional video images picked up in this state can be visually recognized as a natural stereoscopic object by a user.

However, when the first camera 1 and the second camera 2 having large casings are aligned in a horizontal direction, a subject is taken with larger parallax than the interval of human eyes, resulting in user's uncomfortable feeling with respect to a stereoscopic video image that the user visually recognizes. Therefore, the first camera 1 and the second camera 2 are disposed on the putting table 6 provided with a half mirror 7. Here, the first camera 1 is disposed on a position on which image light of a subject is directly incident via the half mirror 7 and the second camera 2 is disposed on a position on which the image light of the subject is reflected by the half mirror 7 to be incident. Accordingly, the first camera 1 and the second camera 2 are disposed so that optical axes of lenses of the first camera 1 and the second camera 2 intersect orthogonally.

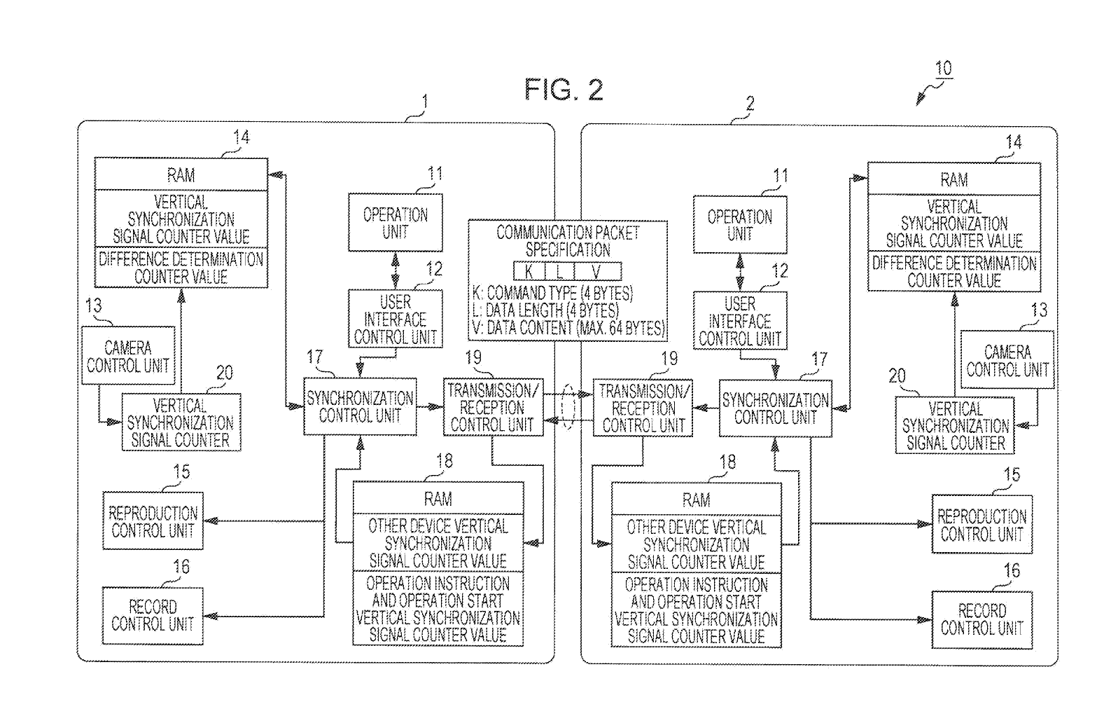

FIG. 2 illustrates an internal configuration example of the stereoscopic video imaging system 10.

The first camera 1 and the second camera 2 have the same function blocks as each other. Therefore, in the following description, an internal configuration example of the first camera 1 is described. In the following description, in order to describe processing of the first camera 1, the first camera 1 may be referred to as “own device” and the second camera 2 may be referred to as “the other device”.

The first camera 1 includes a user interface control unit 12 which receives operation input from the operation unit 11, a camera control unit 13 which controls an imaging operation, and a RAM 14. The user interface control unit 12 displays a graphical user interface (GUI) on a screen when the operation unit 11 is a touch panel display. The first camera 1 further includes a reproduction control unit 15 which controls reproduction of a video image recorded in a recording unit which is not shown and a record control unit 16 which performs control when a video image is recorded in the recording unit. The first camera 1 further includes a synchronization control unit 17 which controls an operation of the second camera 2 so that an imaging operation and reproduction or record of a video image are performed in synchronization with processing of the second camera 2. The first camera 1 further includes a RAM 18 which stores various counter values and a transmission/reception control unit 19 which controls transmission/reception of a communication packet transmitting through the synchronization control line 3.

The user interface control unit 12 performs processing of receiving operation input performed with a button which is not shown and provided to the operation unit 11, processing of receiving operation input received from a remote controller which is not shown, and processing of receiving operation input performed with a remote such as wireless LAN. The user interface control unit 12 processes an instruction and the like given by operation input inputted from the graphical user interface such as a touch panel and performs processing to display various menus and messages on a touch panel display or the like. Further, the user interface control unit 12 notifies the synchronization control unit 17 of the instruction given by the operation input received from the operation unit 11.

The camera control unit 13 is used as an imaging control unit which controls an operation of an imaging unit having a first imaging element which is not shown and outputs a video signal in the first processing frame for every vertical synchronization signal which is inserted between first processing frames, by incident light of a subject incident through a lens which is not shown. The second camera 2 includes an imaging unit having a second imaging element. The camera control unit 13 controls an imaging element such as a complementary metal oxide semiconductor (CMOS) image sensor which is not shown, a video image processing processor, and drive of an optical system driving unit including a lens and the like. The camera control unit 13 corrects a video signal outputted by the imaging element, in a pixel unit and performs control of auto focusing processing, auto white balance processing, and the like with respect to the optical system driving unit.

Into the RAM 14, a vertical synchronization signal counter 20 which counts the number of generation times of a vertical synchronization signal for each frame obtained from the camera control unit 13 writes a vertical synchronization signal counter value which is used as the frame number of processing frames. The vertical synchronization signal counter 20 is used as a counting unit which counts the number of generation times of the vertical synchronization signal generated by the imaging element as the frame number of the first processing frames. The vertical synchronization signal counter 20 counts the number of vertical synchronization signals interrupting from the imaging element that the camera control unit 13 controls in imaging, and the RAM 14 stores the number of vertical synchronization signals written by the vertical synchronization signal counter 20.

The reproduction control unit 15 performs control of access processing such as writing and reading of a clip file with respect to a recording medium which is not shown, control of processing of clip information, control of decoding processing of the clip file, and the like. The first camera 1 administrates a video file including a video signal which is picked up from start to stop of one recording, by a unit of “clip”; writing and reading with respect to a recording medium can be performed to every clip file. The record control unit 16 performs control of access processing with respect to a recording medium, control of generation processing of a clip file, control of salvage processing to salvage a discarded clip file, control of encode processing of a video signal, and the like.

The synchronization control unit 17 performs following notification to the second camera 2. The second camera 2 is the other imaging device which is connected by the synchronization control line 3 which transmits a control signal. The synchronization control unit 17 receives the number of generation times, which is notified from the second camera 2, of the vertical synchronization signal which is generated by a second imaging element of the second camera 2 and is inserted between second processing frames. The synchronization control unit 17 calculates the number of generation times of the vertical synchronization signal inserted between second processing frames, based on a difference value with respect to the number of generation times of the vertical synchronization signal inserted between the first processing frames. Further, the synchronization control unit 17 notifies the second camera 2 of timing on which the second camera 2 starts an instructed operation after elapse of predetermined period and an instruction given by operation input based on the number of generation times of the vertical synchronization signal inserted between the second frames. At this time, the first camera 1 performs an instructed operation after elapse of the predetermined period from a time point on which the operation input is performed.

The synchronization control unit 17 preliminarily matches timing on which a vertical synchronization signal of the first processing frame is generated and timing on which a vertical synchronization signal of the second processing frame is generated. Here, the second camera 2 counts the number of generation times of the vertical synchronization signal inserted between the second processing frames as the frame number of the second processing frames. At this time, the synchronization control unit 17 determines whether a difference value of the frame number calculated by using the frame number of the second processing frames received from the second camera 2 and the frame number of the first processing frames is constant for a plurality of frame periods, every time the second imaging element generates a vertical synchronization signal. When the difference value is constant for the plurality of frame periods, the synchronization control unit 17 notifies the second camera 2 of the frame number obtained by adding the plurality of frame periods to the calculated frame number of the second processing frames as timing on which the second camera 2 starts an operation. By such control, the first camera 1 controls timing on which the second camera 2 starts an instructed operation. Here, the “operation instructed” by operation input of the operation unit 11 includes imaging start or stop or video reproduction start or stop, and the first and second processing frames include an imaging frame or a reproduction frame.

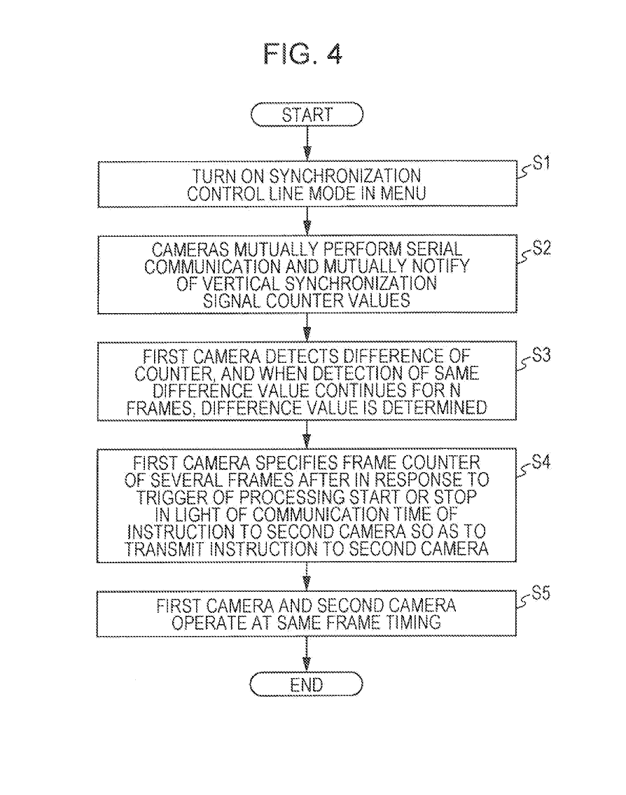

Thus, the synchronization control unit 17 obtains difference between counter values of vertical synchronization signals of the first camera 1 and the second camera 2 and performs control of synchronizing timing of operation instruction with the second camera 2. Though detailed processing of the synchronization control unit 17 will be described later, all processing shown in flowcharts of FIGS. 4 to 7 is performed by the synchronization control unit 17.

Further, the synchronization control unit 17 has an interface for transmitting/receiving data with respect to the camera control unit 13 and performs transmission/reception control unit interface processing with respect to the transmission/reception control unit 19. This processing is performed by a module handling an interface with respect to the transmission/reception control unit 19. The RAM 18 stores counter values of vertical synchronization signals which are mutually received by the first camera 1 and the second camera 2, operation instruction performed by the first camera 1, a counter value of a vertical synchronization signal which is a trigger of start of operation instruction, and the like.

The transmission/reception control unit 19 performs transmission reception processing of a communication packet, processing of transmitting a communication packet to the second camera 2, processing of converting a communication packet in accordance with a specified communication protocol, processing of controlling a communication device including a line terminal and the like, and so forth. The synchronization control unit 17 calculates start timing (based on the number of generation times of the vertical synchronization signal counter value in this example) of a processing frame which is executed to synchronize timings of start or stop of processing. Then, the transmission/reception control unit 19 requests to transmit control data for instructing the second camera 2 on an operation to be performed and the processing frame number, to the second camera 2.

The first camera 1 preliminarily synchronizes a processing frame of the first camera 1 and a processing frame of the second camera 2 by performing genlock with respect to the second camera 2. This synchronization is performed on generating timing of a vertical synchronization signal and the synchronization control unit 17 controls such that a mismatching amount of the synchronization timings is within time of approximately one line. In this example, control based on a master-servant relationship in which the first camera 1 is set to be a main device and the second camera 2 is set to be a sub device is performed, and synchronization of a processing frame of the second camera 2 is controlled to be matched with a processing frame of the first camera 1 in accordance with an instruction of the first camera 1.

As described above, start timing of the processing frame of the first camera 1 and start timing of the processing frame of the second camera 2 are synchronized with each other by genlock. Then, the first camera 1 and the second camera 2 detect a difference value of vertical synchronization signal counter values respectively counted by software programs operating in respective cameras. Here, a vertical synchronization signal is generated at timing on which a processing frame starts, and the synchronization control unit 17 of the first camera 1 figures out the frame number of processing frames in which the second camera 2 operates, based on the difference value. Accordingly, when the first camera 1 which is the main device receives operation instruction which is used for performing start or stop of processing and given by operation input of a user, the first camera 1 controls an operation of the second camera 2 so as to make the second camera 2 perform start or stop of processing simultaneously with the first camera 1. Thus, the first camera 1 performs synchronization control by which timing of processing of the second camera 2 is matched with every frame which is timing of processing of the first camera 1.

A communication packet transmitted between the cameras is composed of “K field (4 bytes)” representing a command type, “L field (4 bytes)” representing a data length, and “V field (maximum 64 bytes)” representing a data content. In the K field, data for instructing synchronization is stored, and in the V field, data content representing start or stop of processing of own device is stored. For example, when data representing a notice of a vertical synchronization signal counter value is included in the K field, a vertical synchronization signal counter value of own device is included in the V field. Further, when information notifying of format of a clip file is included in the K field, information representing a picture size of a video image, a frame rate, and a bit rate is included in the V field.

By transmitting/receiving a communication packet via the synchronization control line 3, the first camera 1 and the second camera 2 controlled by the software program can perform processing in a mutually-synchronized manner for every frame. Therefore, processing to simultaneously perform an operation to start or stop recording of video images picked up at the same timing for every frame, and processing to simultaneously reproduce or stop a content of the same format for every frame are enabled.

Here, the first camera 1 and the second camera 2 are used also as reproduction devices which reproduce a video image in a synchronized manner. In this case, the second camera 2 is used as the other reproduction device which is connected by the synchronization control line 3. At this time, the vertical synchronization signal counter 20 counts the number of generation times of the vertical synchronization signal inserted between first frames of a video signal which is reproduced by the reproduction control unit 15 of the second camera 2 as the frame number of the second processing frames of the second camera 2. Then, the generation number, which is notified by the second camera 2, of vertical synchronization signals which are generated by the imaging element of the second camera 2 and inserted between the second processing frames is obtained. The number of generation times of the vertical synchronization signal inserted between the second processing frames is calculated based on a difference value between the above-mentioned generation number and the number of generation times of the vertical synchronization signal inserted between the first processing frames. Then, based on the number of generation times of the vertical synchronization signal inserted between the second processing frames, the second camera 2 is notified of timing on which the second camera 2 starts an instructed operation after elapse of a predetermined period and instruction given by operation input. At this time, the first camera 1 notifies the second camera 2 of the timing of start of the operation and the instruction given by operation input and performs a notified operation after elapse of the predetermined period from a time point on which the operation input is performed. The operation instructed by the operation input of the operation unit 11 includes start or stop of imaging and the first and second processing frames include an imaging frame or a reproduction frame.

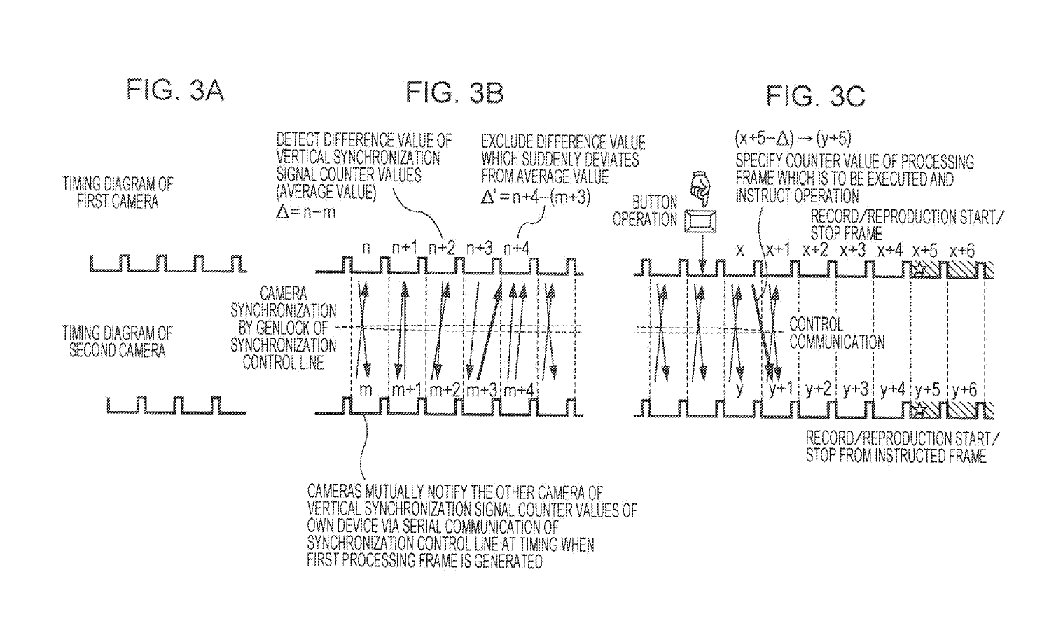

FIGS. 3A to 3C are timing diagrams illustrating an example that operation timing of the second camera 2 is controlled by the first camera 1.

FIG. 3A illustrates an example of a timing diagram in a state that synchronization of the first camera 1 and the second camera, 2 is not controlled.

The first camera 1 and the second camera 2 use vertical synchronization signals which are respectively generated at different timings so as to match start timings, and perform processing of imaging or reproduction on the basis of a processing frame set within a period between adjacent vertical synchronization signals. The first camera 1 and the second camera 2 operates in processing frames of the same frame rate. However, it is difficult to precisely match timings on which a user operates the operation unit 11 of respective cameras to power on, and therefore timings on which processing frames start are different from each other. Accordingly, if an image of a subject is picked up in a state that timings of start of processing frames are different from each other as related art, an operation to match start or stop of processing has to be performed after the image pick up.

FIG. 3B illustrates an example of a processing frame of the second camera 2 which is subject to genlock based on a processing frame of the first camera 1.

In this example, such control is performed that start timing of a processing frame of the second camera 2 is matched with start timing of a processing frame of the first camera 1, and a vertical synchronization signal of the first camera 1 is used as a synchronization signal for matching start timings of processing frames. Genlock is performed with respect to a processing frame of the second camera 2 by a synchronization control signal transmitted from the first camera 1 via the synchronization control line 3. Here, the first camera 1 and the second camera 2 have the same configuration, so that a processing frame of the second camera 2 can be used as a synchronization signal to perform genlock of a processing frame of the first camera 1.

Here, processing to match start timings of processing frames of the first camera 1 and the second camera 2 is described.

First, as soon as a vertical synchronization signal is generated as first timing of a processing frame, the first camera 1 notifies the second camera 2 of a counted vertical synchronization signal counter value via the synchronization control line 3. This vertical synchronization signal counter value is used as a counter value of a processing frame.

In a similar manner, as soon as a vertical synchronization signal is generated as first timing of a processing frame, the second camera 2 notifies the first camera 1 of a counted vertical synchronization signal counter value via the synchronization control line 3. In FIG. 3B, vertical synchronization signal counter values of the first camera 1 are counted as n, n+1, . . . , and vertical synchronization signal counter values of the second camera 2 are counted as m, m+1, . . . , for the sake of convenience of the description.

The first camera 1 and the second camera 2 mutually notify of vertical synchronization signal counter values within a period of one frame. This operation is performed over several frames. Then, the synchronization control unit 17 of the first camera 1 calculates a difference value Δ which is obtained by subtracting the vertical synchronization signal counter value of the second camera 2 which are obtained for several frames from the vertical synchronization signal counter value of the first camera 1. In this example, a value is obtained by a difference value Δ=n−m, and when difference values Δ calculated over several frames are continuously same values as each other, the difference value Δ is obtained as an average value.

Here, as the (m+3)th frame of the second camera 2, there is a case where a counter value of the (m+3)th frame is not notified within corresponding (n+3)th frame of the first camera 1 but is notified in the next (n+4)th frame. For example, there is a case where it is difficult for the first camera 1 to notify the second camera 2 of the frame number of the first processing frame within a period of the first processing frame, or to receive the frame number of the second processing frame from the second camera 2 within a period of the first processing frame. In this case, the synchronization control unit 17 of the first camera 1 notifies the second camera 2 of the frame number of a first processing frame over a frame period following the first processing frame. Alternatively, the first camera 1 receives the frame number of a second processing frame from the second camera 2. Accordingly, the first camera 1 and the second camera 2 can mutually securely notify of the frame numbers of processing frames.

As shown in FIG. 3B, when the synchronization control unit 17 obtains a second difference value Δ′ which is different from the difference value Δ, which is obtained to be same over predetermined times or more, over less than predetermined times, the synchronization control unit 17 discards the second difference value Δ′. In the example of FIG. 3B, the second difference value Δ′ is obtained by Δ′=(n+4)−(m+3)=n−m+1. Thus, the second difference value Δ′ which suddenly deviates from an average value is discarded. Accordingly, the synchronization control unit 17 of the first camera 1 can figure out how much a processing frame of the second camera 2 deviates from a processing frame of the first camera 1, based on a difference value Δ.

FIG. 3C illustrates an example of timing at which the first camera 1 and the second camera 2 actually perform start or stop of processing.

As shown in FIG. 3B, the synchronization control unit 17 of the first camera 1 figures out a difference value Δ.

Here, in FIG. 3C, processing frames of the first camera 1 are counted as x, x+1, . . . , and processing frames of the second camera 2 are counted as y, y+1, . . . , for the sake of convenience of the description.

When start or stop of processing is performed from the (x+5)th frame, the synchronization control unit 17 gives an instruction to the second camera 2 to overwrite a counter value of the (x+5−Δ)th frame on a counter value of the (y+5)th frame. At this time, the synchronization control unit 17 of the second camera 2 rewrites the counter value of the (y+5)th frame into the counter value of the (x+5−Δ)th frame. Accordingly, the first camera 1 and the second camera 2 perform start or stop of processing at same timing shown by a star mark in FIG. 3C as a counter value of the same frame.

A processing example of the synchronization control unit 17 is now especially described as a processing example of the stereoscopic video imaging system 10 with reference to FIGS. 4 to 7. Here, in this example, the synchronization control unit 17 is described because the first camera 1 is set to be a main device. However, even in a case where the second camera 2 is used as a main device, the second camera 2 can perform processing same as that of the synchronization control unit 17 described below.

FIG. 4 illustrates a processing example of the first camera 1.

First, when the synchronization control line 3 is connected to the line terminals of the first camera 1 and the second camera 2, the synchronization control line mode is turned on by operation input of the operation unit 11 which is performed by a user with a menu screen which is not shown (step S1). When the synchronization control line mode is turned on, imaging processing of a video image or reproducing processing of a video image can be performed in a synchronized manner between the first camera 1 and the second camera 2 in processing frames of respective cameras under a master-servant relationship in which the first camera 1 is set to be a main device and the second camera 2 is set to be a sub device. On the other hand, when the synchronization control line mode is turned off, the respective cameras independently operate and therefore do not mutually influence.

Next, the first camera 1 and the second camera 2 mutually notify of vertical synchronization signal counter values via the synchronization control line 3 by serial communication (step S2). Subsequently, the synchronization control unit 17 of the first camera 1 detects difference between the vertical synchronization signal counter value of own device and the vertical synchronization signal counter value which is received from the second camera 2. At this time, if the same difference value is continuously obtained for N frames (in this example, 5 frames), the first camera 1 determines the difference value (step S3).

Then, the first camera 1 receives an instruction of start or stop of processing by an operation signal which is generated in response to an input operation performed on the operation unit 11. In response to this instruction, the first camera 1 specifies a counter value of a processing frame of several frames after in light of communication time used for instructing the second camera 2, so as to transmit an operation instruction to the second camera 2 (step S4). The timing diagram shown in FIG. 3C shows an execution of 5 frames after.

Thus, the first camera 1 and the second camera 2 perform the same operation as each other in synchronization with the timing of the vertical synchronization signals which are generated at the same timing (step S5). Accordingly, a user can make the second camera 2 perform the same operation only by operate the first camera 1.

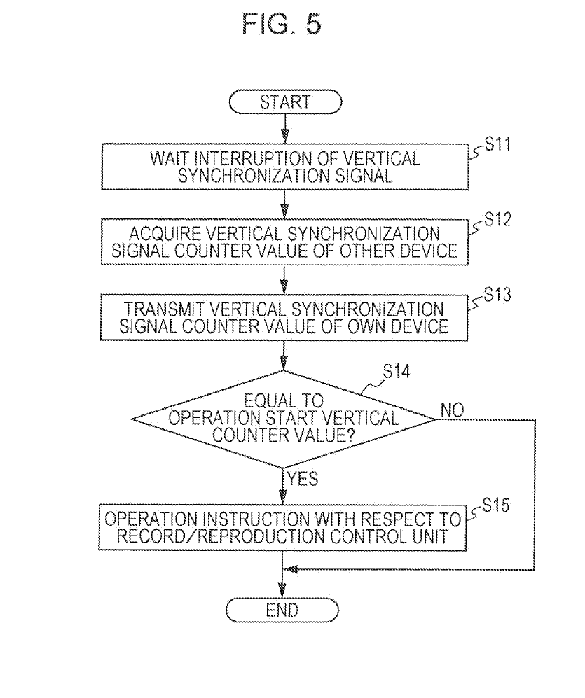

Next, an example of a processing, which is performed by the synchronization control unit 17, of an interface with respect to each unit is described with reference to FIGS. 5 to 7. In the description below, processing that the synchronization control unit 17 performs input/output of data with respect to each control unit is called “processing of an interface”.

FIG. 5 illustrates an example of processing, which is performed by the synchronization control unit 17, of an interface of the camera control unit 13.

First, the synchronization control unit 17 waits interruption of a vertical synchronization signal which is generated by an imaging element (step S11). When the interruption of the vertical synchronization signal occurs, the vertical synchronization signal counter 20 writes a vertical synchronization signal counter value in the RAM 14. Then, the synchronization control unit 17 acquires the vertical synchronization signal counter value from the RAM 14 (step S12).

The vertical synchronization signal counter value is repeatedly counted up from “0” to “255” by the vertical synchronization signal counter 20 after the first camera 1 is powered on. Here, the vertical synchronization signal counter value at a time point on which the vertical synchronization signal counter 20 starts counting has a random value. Further, if synchronization between the first camera 1 and the second camera 2 is stable, the difference value Δ is a fixed value, and an absolute value of the vertical synchronization signal counter value at a time point of starting an operation is calculated every time. Accordingly, the vertical synchronization signal counter value does not have to be reset to “0”.

Next, the synchronization control unit 17 transmits the vertical synchronization signal counter value read out from the RAM 14 to the second camera 2 (step S13). The processing to transmit the vertical synchronization signal counter value is performed by a module which processes an interface of the camera control unit 13. Then, the synchronization control unit 17 requests transmission from the transmission/reception control unit 19, and therefore transmission processing is performed.

Next, the synchronization control unit 17 determines whether the vertical synchronization signal counter value of own device is equal to a vertical synchronization signal counter value at a time point on which the second camera 2 stars an operation (step S14). When the vertical synchronization signal counter values are equal to each other, the synchronization control unit 17 performs reproducing instruction or recording instruction of a video image with respect to the reproduction control unit 15 or the record control unit 16 (step S15). When the vertical synchronization signal counter values are different from each other, the synchronization control unit 17 does not perform any processing and ends the processing.

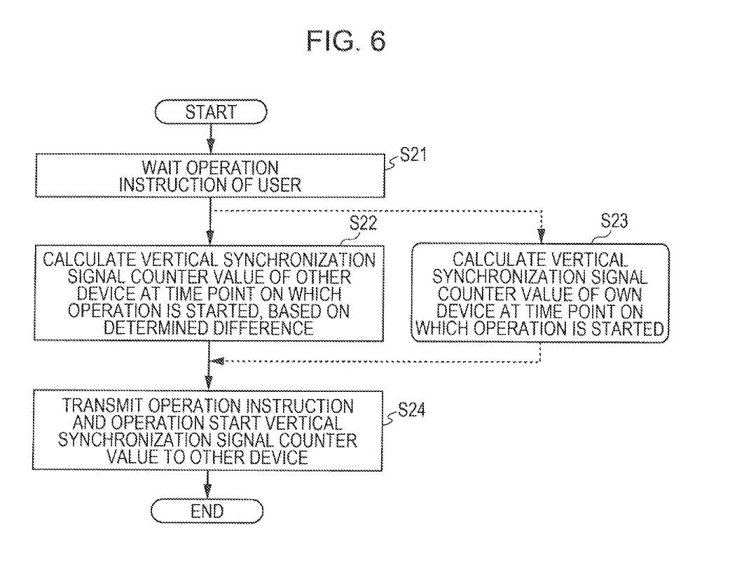

FIG. 6 illustrates an example of processing, which is performed by the synchronization control unit 17, of an interface of the user interface control unit 12.

First, the synchronization control unit 17 waits an operation instruction by an operation signal which is generated in response to operation input of a user (step S21). However, when the operation instruction from the user is given in a processing frame is indefinite. Therefore, the synchronization control unit 17 performs genlock in response to an operation instruction so that vertical synchronization signals are simultaneously generated between the first camera 1 and the second camera 2, being able to start the instructed operation from the beginning of the processing frame which is the timing at which the vertical synchronization signal is generated.

Further, the first camera 1 notifies of the operation instruction which is operate-inputted by the operation unit 11, by transmitting an operation signal to the second camera 2. Here, the timing when the operation signal reaches the second camera 2 is indefinite and therefore when the operation is actually performed is unclear. Therefore, the first camera 1 and the second camera 2 preliminarily obtain a difference value Δ from vertical synchronization signal counter values counted by respective vertical synchronization signal counters 20. With this, a vertical synchronization signal counter value at which the first camera 1 and the second camera 2 can start an operation in a synchronized manner is calculated in light of the difference value Δ.

Then, the synchronization control unit 17 of the first camera 1 calculates a vertical synchronization signal counter value at a time point on which the second camera 2 starts an operation, based on the difference value Δ which is determined by the vertical synchronization signal counter value received from the second camera 2 (step S22). Further, the synchronization control unit 17 of the first camera 1 calculates a vertical synchronization signal counter value at a time point on which the first camera 1 starts an operation, in parallel with the processing of step S22 (step S23).

A dashed line branched to step S23 on the subsequent step of step S21 represents processing which is performed when the first camera 1 is set to be a sub device. This processing is provided because processing to be performed varies depending on whether a parameter of an operation instruction received from the operation unit 11 is a counter value of own device or a counter value of the other device. Subsequently, the synchronization control unit 17 transmits an operation signal for performing an operation instruction and the vertical synchronization signal counter value at a time point on which the operation is started to the second camera 2 (step S24), and the processing is ended.

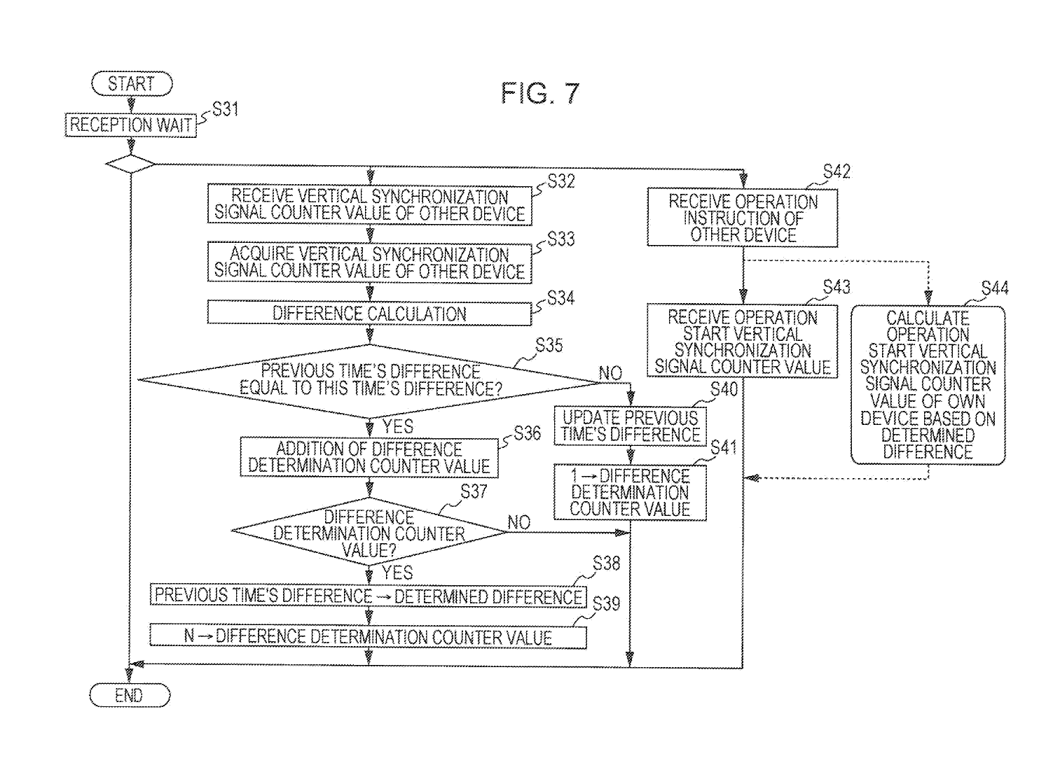

FIG. 7 illustrates an example of processing, which is performed by the synchronization control unit 17, of an interface of the transmission/reception control unit 19.

First, the synchronization control unit 17 of the first camera 1 waits reception of a vertical synchronization signal counter value received from the transmission/reception control unit 19 (step S31). If the vertical synchronization signal counter value is not received from the second camera 2, the processing is ended.

On the other hand, when the transmission/reception control unit 19 receives the vertical synchronization signal counter value from the second camera 2 (step S32), the transmission/reception control unit 19 writes the vertical synchronization signal counter value in the RAM 18. Subsequently, the synchronization control unit 17 acquires the vertical synchronization signal counter value from the RAM 18 (step S33). Then, the synchronization control unit 17 calculates a difference value Δ between a vertical synchronization signal counter value of own device read from the RAM 14 and the vertical synchronization signal counter value of the second camera 2 read out from the RAM 18 (step S34).

The synchronization control unit 17 calculates a difference value Δ for every frame and the latest difference value Δ is calculated in step S34. In the following description, the difference that the synchronization control unit 17 calculates one frame before is a value which is obtained by a vertical synchronization signal counter value of one frame before, thereby being called “previous time's difference”. While, the difference value Δ calculated in step S34 is called “this time's difference”. Then, the synchronization control unit 17 determines whether this time's difference is equal to the previous time's difference (step S35). Subsequently, the synchronization control unit 17 writes a difference determination counter value, to which the number is added when this time's difference is equal to the previous time's difference, in the RAM 14 so as to determine whether difference values Δ have a constant value over several times (step S36).

Then, the synchronization control unit 17 determines whether the difference value Δ is a value enabling an increase of the difference determination counter value or an abnormal value corresponding to a second difference value Δ′ (step S37). When the difference value Δ is an abnormal value, the processing is not performed. On the other hand, when the difference value Δ is a value enabling an increase of the difference determination counter value, processing of writing the previous time's difference over a determined difference in step S38 of subsequent processing.

In this example, a difference determination counter value is used so as to determine a difference value Δ of a vertical synchronization signal counter value. For example, as shown in FIG. 3C described above, in a case where a communication packet which is transmitted through the synchronization control line 3 is delayed, this time's difference may be different from the previous time's difference. In order to enable discarding of the difference value Δ which is obtained as this time's difference in such case, such control is performed that this time's difference is not considered as a correct difference value Δ in a case where this time's difference and the previous time's difference do not have the same value N times (five times in this example) in a row.

Here, when the difference value Δ varies, the synchronization control unit 17 once writes the varied difference value Δ in the RAM 14 as a “previous time's difference”. Subsequently, when the same difference value Δ is obtained, the synchronization control unit 17 increases the difference determination counter value in the RAM 14 by 1. Further, when this time's difference and the previous time's difference have the same value continuously, the synchronization control unit 17 continues to increase the difference determination counter value each time. Thus, in a case where this time's difference and the previous time's difference have the same value over N frames, a “determined difference value” represented by the above-described difference value Δ is obtained (step S38). Further, in a case where this time's difference and the previous time's difference have the same value for N times in a row, a value of “N” which is the difference determination counter value is written over the difference determination counter value (step S39), and the processing is ended. Here, the value of “N” is increased every time this time's difference and the previous time's difference have the same value.

When this time's difference and the previous time's difference are different from each other in the processing of step S35, the previous time's difference written in the RAM 14 is updated by this time's difference (step S40), and the difference determination counter value is rewritten by a default value “1” (step S41). Subsequently, the processing of steps S31 to S39 is repeated so as to obtain whether a value represented by this time's difference is a determined difference Δ.

Here, there is a case where the first camera 1 is set to be a sub device and the second camera 2 is set to be a main device. In this case, the transmission/reception control unit 19 of the first camera 1 receives an operation signal from the second camera 2 and the synchronization control unit 17 of the first camera 1 interprets an operation instructed by the second camera 2 (step S42). Further, the transmission/reception control unit 19 of the first camera 1 receives a vertical synchronization signal counter value at a time point on which an operation is started, from the second camera 2 (step S43) and writes this vertical synchronization signal counter value in the RAM 18 of the first camera 1. Then, the synchronization control unit 17 of the first camera 1 calculates a vertical synchronization signal counter value at a time point on which an operation of own device is started, based on a determined difference value (step S44) in parallel with the processing of step S43 and performs the operation controlled by the second camera 2.

According to the stereoscopic video imaging system 10 of the above-described embodiment, a difference value Δ of vertical synchronization signal counter values is obtained in a state that generation timings of vertical synchronization signals are mutually matched by using the first camera 1 and the second camera 2 having the master-servant relationship. Then, the number of frames in which start of stop of processing is actually performed is determined in light of this difference value Δ and thus the start or stop of processing can be simultaneously performed at a reach of this frame number. At this time, the second camera 2 performs the same operation as that of the first camera 1 when a user performs operation input only with respect to the operation unit 11 of the first camera 1 which is a main device, for example. Accordingly, start or stop of processing of two cameras can be precisely controlled in synchronization with a start timing of a processing frame.

Further, the start timing of a processing frame is matched with the generation timing of a vertical synchronization signal of a video signal, so that operations of respective processing frames can be accurately matched. Accordingly, an operation to adjust processing frames does not have to be performed after a subject is imaged, so that an editing operation becomes more efficient. Further, two cameras can be made perform a reproduction operation in a synchronized manner in reproduction of a video image, so that uncomfortable feeling due to mismatched processing frames with respect to a stereoscopic image can be eliminated.

Further, difference values Δ are obtained over predetermined times or more, so that the values have high credibility. Therefore, processing frames can be easily matched by using the difference value Δ. Further, a user does not have to think of matching start or stop of processing because the second camera 2 automatically operates in synchronization with the first camera 1 only by an operation of the first camera 1.

Furthermore, the second difference value Δ′ which is obtained as an abnormal value is discarded, so that the second difference value Δ′ does not affect synchronization control. From this point, credibility of synchronization control of the first camera 1 and the second camera 2 can be enhanced.

### 2. Modification

In the above-described embodiment, such example that the first camera 1 and the second camera 2 are disposed in the vertical direction is described. However, the first camera 1 and the second camera 2 may be aligned in a horizontal direction by reducing sizes of casings of the first camera 1 and the second camera 2.

Further, in the example, the synchronization control line 3 is used as a wired cable which is connected to the transmission/reception control unit 19 is described. However, a communication packet may be wirelessly transmitted by using an adapter compatible with a wireless communication standard as the transmission/reception control unit 19.

The series of processing in the embodiment described above may be performed by either hardware or software. When the series of processing is performed by software, the processing can be performed by a computer in which a program constituting the software is incorporated in dedicated hardware or by a computer in which a program for executing various functions is installed. For example, the processing may be performed by installing a program constituting desired software in a general-purpose personal computer.

Further, a recording medium in which a program code of software for realizing a function of the above-described embodiment is recorded may be provided to a system or an apparatus. Furthermore, it is apparent that the function is realized by reading out and executing a program code stored in the recording medium by a computer (or a control device such as a CPU) of the system or the apparatus.

Examples of the recording medium for providing the program code in this case include a flexible disk, a hard disk, an optical disk, a magneto-optical disk, a CD-ROM, a CD-R, a magnetic tape, a nonvolatile memory card, and a ROM.

The function of the above-described embodiment is realized by executing the program code read out by the computer. In addition, an OS operating on the computer or the like performs part or whole of actual processing based on an instruction of the program code. A case where the function of the above-described embodiment is realized by the processing is also included.

It should be noted that embodiments of the present disclosure are not limited to the above-described embodiment, and various alterations and modifications occur within the scope of the present disclosure.

The present disclosure may have the following configurations.

(1) An imaging device including

an operation unit configured to instruct an operation by operation input,

an imaging control unit configured to control an operation of an imaging unit having a first imaging element that outputs a video signal in a first processing frame for every vertical synchronization signal that is inserted between first processing frames, by incident light of a subject incident through a lens,

a counting unit configured to count a number of generation times of the vertical synchronization signal generated by the first imaging element, and

a control unit that calculates a number of generation times of the vertical synchronization signal that is inserted between second processing frames based on a difference value between a number of generation times, which is notified from the other imaging device, of the vertical synchronization signal that is generated by a second imaging element included in the other imaging device, which is connected by a control line that transmits a control signal, and inserted between the second processing frames and a number of generation times of the vertical synchronization signal that is inserted between the first processing frames, so as to notify the other imaging device of timing at which the other imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

(2) The imaging device according to (1), in which

the counting unit counts a number of generation times of the vertical synchronization signal that is generated by the first imaging element as a frame number of the first processing frames, and

the control unit notifies the other imaging device of a frame number obtained by adding a plurality of frame periods to a frame number of the second processing frames, which is calculated when a difference value between a frame number of the second processing frames received from the other imaging device every time the second imaging element generates the vertical synchronization signal and a frame number of the first processing frames is constant for the plurality of frame periods, as timing at which the other imaging device starts an operation, in a case where timing on which a vertical synchronization signal of the first processing frame is generated and timing on which a vertical synchronization signal of the second processing frame is generated are preliminarily matched with each other and the other imaging device counts the number of generation times of the vertical synchronization signal inserted between the second processing frames as the frame number of the second processing frames.

(3) The imaging device according to (1) or (2), in which when it is difficult for the control unit to notify the other imaging device of the frame number of the first processing frames within a period of the first processing frame or to receive the frame number of the second processing frames from the other imaging device within the period of the first processing frame, the control unit notifies the other imaging device of the frame number of the first processing frames or receives the frame number of the second processing frames from the other imaging device over a frame period following the first processing frame.

(4) The imaging device according to any one of (1) to (3), in which when the control unit obtains a second difference value, which is different from the difference value obtained over predetermined times or more, over less than the predetermined times, the control unit discards the second difference value.

(5) The imaging device according to any one of (1) to (3), in which an operation instructed by the operation input of the operation unit includes one of start and stop of imaging and the first and second processing frames include one of an imaging frame and a reproduction frame.

(6) A synchronization control method including

instructing an operation by operation input,

controlling an operation of an imaging unit having a first imaging element that outputs a video signal in a first processing frame for every vertical synchronization signal that is inserted between first processing frames, by incident light of a subject incident through a lens,

counting a number of generation times of the vertical synchronization signal generated by the first imaging element, and

calculating a number of generation times of the vertical synchronization signal that is inserted between second processing frames based on a difference value between a number of generation times, which is notified from the other imaging device, of the vertical synchronization signal that is generated by a second imaging element included in the other imaging device, which is connected by a control line that transmits a control signal, and inserted between the second processing frames and a number of generation times of the vertical synchronization signal that is inserted between the first processing frames, so as to notify the other imaging device of timing at which the other imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

(7) A reproduction device including

an operation unit configured to instruct an operation by operation input,

a counting unit configured to count a number of generation times of a vertical synchronization signal that is inserted between first processing frames of a video signal that is read out from a recording unit and reproduced, and

a control unit that calculates a number of generation times of the vertical synchronization signal that is inserted between second processing frames based on a difference value between a number of generation times, which is notified from the other reproduction device, of the vertical synchronization signal that is generated by an imaging element included in the other reproduction device, which is connected by a control line that transmits a control signal, and inserted between the second processing frames and a number of generation times of the vertical synchronization signal that is inserted between the first processing frame, so as to notify the other reproduction device of timing at which the other reproduction device-starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

(8) A stereoscopic video imaging system including

a first imaging device and

a second imaging device; and

the first imaging device includes
a first operation unit configured to instruct an operation by operation input,
a first imaging control unit configured to control an operation of an imaging unit having a first imaging element that outputs a video signal in a first processing frame for every vertical synchronization signal that is inserted between first processing frames, by incident light of a subject incident through a lens,
a first counting unit configured to count a number of generation times of the vertical synchronization signal generated by the first imaging element, and
a first control unit that calculates a number of generation times of the vertical synchronization signal that is inserted between second processing frames based on a difference value between a number of generation times, which is notified from the second imaging device, of the vertical synchronization signal that is generated by a second imaging element included in the second imaging device, which is connected by a control line that transmits a control signal, and inserted between the second processing frames and a number of generation times of the vertical synchronization signal that is inserted between the first processing frames, so as to notify the second imaging device of timing at which the second imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed; and

the second imaging device includes
a second imaging control unit configured to control an operation of a second imaging unit having a second imaging element that outputs a video signal in a second processing frame for every vertical synchronization signal that is inserted between second processing frames, by incident light of a subject incident through a lens,
a second counting unit configured to count a number of generation times of the vertical synchronization signal generated by the second imaging element, and
a second control unit configured to notify the first imaging device of the number of generation times of the vertical synchronization signal inserted between the second processing frames and perform an instructed operation after elapse of a predetermined period from a time point on which the operation input is performed, based on timing which is received from the first imaging device and on which the instructed operation is started after the elapse of the predetermined period and an instruction given by the operation input and received from the first imaging device.

The present disclosure contains subject matter related to that disclosed in Japanese Priority Patent Application JP 2011-066254 filed in the Japan Patent Office on Mar. 24, 2011, the entire contents of which are hereby incorporated by reference.

What is claimed is:

1. An imaging device, comprising:
an operation unit configured to instruct an operation by operation input;
an imaging control unit configured to control an operation of an imaging unit having a first imaging element that outputs a video signal in a first processing frame for every vertical synchronization signal that is inserted between first processing frames, by incident light of a subject incident through a lens;
a counting unit configured to count a number of generation times of the vertical synchronization signal generated by the first imaging element; and
a control unit that calculates a number of generation times of the vertical synchronization signal that is inserted between second processing frames based on a difference value between a number of generation times, the number of generation times being notified from the other imaging device, of the vertical synchronization signal that is generated by a second imaging element included in the other imaging device, the other imaging device being connected by a control line that transmits a control signal, and inserted between the second processing frames and a number of generation times of the vertical synchronization signal that is inserted between the first processing frames, so as to notify the other imaging device of timing at which the other imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

2. The imaging device according to claim 1, wherein
the counting unit counts a number of generation times of the vertical synchronization signal that is generated by the first imaging element as a frame number of the first processing frames, and
the control unit notifies the other imaging device of a frame number obtained by adding a plurality of frame periods to a frame number of the second processing frames, the frame number of the second processing frames being calculated when a difference value between a frame number of the second processing frames received from the other imaging device every time the second imaging element generates the vertical synchronization signal and a frame number of the first processing frames is constant for the plurality of frame periods, as timing at which the other imaging device starts an operation, in a case where timing on which a vertical synchronization signal of the first processing frame is generated and timing on which a vertical synchronization signal of the second processing frame is generated are preliminarily matched with each other and the other imaging device counts the number of generation times of the vertical synchronization signal inserted between the second processing frames as the frame number of the second processing frames.

3. The imaging device according to claim 2, wherein when it is difficult for the control unit to notify the other imaging device of the frame number of the first processing frames within a period of the first processing frame or to receive the frame number of the second processing frames from the other imaging device within the period of the first processing frame, the control unit notifies the other imaging device of the frame number of the first processing frames or receives the frame number of the second processing frames from the other imaging device over a frame period following the first processing frame.

4. The imaging device according to claim 3, wherein when the control unit obtains a second difference value, the second difference value being different from the difference value obtained over predetermined times or more, over less than the predetermined times, the control unit discards the second difference value.

5. The imaging device according to claim 4, wherein an operation instructed by the operation input of the operation unit includes one of start and stop of imaging and the first and second processing frames include one of an imaging frame and a reproduction frame.

6. A synchronization control method, comprising:
instructing an operation by operation input;
controlling an operation of an imaging unit having a first imaging element that outputs a video signal in a first processing frame for every vertical synchronization signal that is inserted between first processing frames, by incident light of a subject incident through a lens;
counting a number of generation times of the vertical synchronization signal generated by the first imaging element; and
calculating a number of generation times of the vertical synchronization signal that is inserted between second processing frames based on a difference value between a number of generation times, the number of generation times being notified from the other imaging device, of the vertical synchronization signal that is generated by a second imaging element included in the other imaging device, the other imaging device being connected by a control line that transmits a control signal, and inserted between the second processing frames and a number of generation times of the vertical synchronization signal that is inserted between the first processing frames, so as to notify the other imaging device of timing at which the other imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

7. A reproduction device, comprising:
an operation unit configured to instruct an operation by operation input;
a counting unit configured to count a number of generation times of a vertical synchronization signal that is inserted between first processing frames of a video signal that is read out from a recording unit and reproduced; and
a control unit that calculates a number of generation times of the vertical synchronization signal that is inserted between second processing frames based on a difference value between a number of generation times, the number of generation times being notified from the other reproduction device, of the vertical synchronization signal that is generated by an imaging element included in the other reproduction device, the other reproduction device being connected by a control line that transmits a control signal, and inserted between the second processing frames and a number of generation times of the vertical synchronization signal that is inserted between the first processing frames, so as to notify the other reproduction device of timing at which the other reproduction device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed.

8. A stereoscopic video imaging system, comprising:
a first imaging device; and
a second imaging device; wherein
the first imaging device includes
a first operation unit configured to instruct an operation by operation input,
a first imaging control unit configured to control an operation of an imaging unit having a first imaging element that outputs a video signal in a first processing frame for every vertical synchronization signal that is inserted between first processing frames, by incident light of a subject incident through a lens,
a first counting unit configured to count a number of generation times of the vertical synchronization signal generated by the first imaging element, and
a first control unit that calculates a number of generation times of the vertical synchronization signal that is inserted between second processing frames based on a difference value between a number of generation times, the number of generation times being notified from the second imaging device, of the vertical synchronization signal that is generated by a second imaging element included in the second imaging device, the second imaging device being connected by a control line that transmits a control signal, and inserted between the second processing frames and a number of generation times of the vertical synchronization signal that is insetted between the first processing frames, so as to notify the second imaging device of timing at which the second imaging device starts an instructed operation after elapse of a predetermined period and an instruction given by the operation input, based on the number of generation times of the vertical synchronization signal that is inserted between the second processing frames, and perform the operation that is notified of after the elapse of the predetermined period from a time point on which the operation input is performed; and
the second imaging device includes
a second imaging control unit configured to control an operation of a second imaging unit having a second imaging element that outputs a video signal in a second processing frame for every vertical synchronization signal that is inserted between second processing frames, by incident light of a subject incident through a lens,
a second counting unit configured to count a number of generation times of the vertical synchronization signal generated by the second imaging element, and
a second control unit configured to notify the first imaging device of the number of generation times of the vertical synchronization signal inserted between the second processing frames and perform an instructed operation after elapse of a predetermined period from a time point on which the operation input is performed, based on timing on which the instructed operation is started after the elapse of the predetermined period and an instruction given by the operation input, the timing and the instruction being received from the first imaging device.
